(19) United States
(12) Patent Application Publication
(10) Pub. No.: US 2005/0197277 A1
(43) Pub. Date: Sep. 8, 2005

(54) Cleaning formulation with brake dust barrier efficacy

(76) Inventors: Laurie A. Gallagher, New Milford, CT (US); Rebecca A. Woodward, Wallingford, CT (US)

Correspondence Address: CANTOR COLBURN, LLP, 55 GRIFFIN ROAD SOUTH, BLOOMFIELD, CT, 06002, US

(21) Appl. No.: 10/796,263

(22) Filed: Mar. 8, 2004

(51) Int. Cl. C11D 3/37

(52) U.S. Cl. 510/475

(57) ABSTRACT

A cleaning formulation includes a cleaning composition present in an amount sufficient to provide cleaning efficacy. The cleaning formulation further includes a brake dust barrier composition present in an amount sufficient to provide brake dust barrier efficacy. The barrier composition after application to a surface is adapted to substantially prevent build-up and/or adherence of brake dust on the surface.

### BACKGROUND OF THE INVENTION

The present invention relates generally to automotive detailing products, and more particularly to such products for use on wheels.

Consumers generally expend a significant portion of their monthly income on automobiles. Further, many consumers are automobile aficionados. As a consequence, many, if not most consumers take pride in their automobiles, and desire that their vehicles be aesthetically pleasing. These consumers take care that their vehicles are kept clean and are in good condition. However, certain occurrences detract from the look of a vehicle. One such occurrence is hard-to-remove brake dust which accumulates on wheel surfaces of some vehicles. This brake dust is not aesthetically pleasing. The dust is the result of friction between the brake rotors and the brake pads. While braking, particles from the rotors, as well as the newer, softer brake pad compounds may be displaced and coat the wheels. On some cars, it may become a significant problem. Brake “dust” is generally a combination of metal filings, carbon fibers, and polymer adhesives. In some instances, the brake dust is mostly metal, specifically iron oxide. The adhesive residues may exacerbate the problem of the brake dust adhering to the wheels. If the wheels are left unattended in this condition, the dust coating may become acidic and etch into the finish of the wheels. Thus, in some instances, brake dust may damage wheel surfaces over time. As such, consumers desire to substantially prevent the adhesion and build-up of brake dust on wheels.

### SUMMARY OF THE INVENTION

The present invention substantially solves the problems and/or drawbacks described above by providing a cleaning formulation which includes a cleaning composition present in an amount sufficient to provide cleaning efficacy. The cleaning formulation further includes a brake dust barrier composition present in an amount sufficient to provide brake dust barrier efficacy. The barrier composition after application to a surface is adapted to substantially prevent build-up and/or adherence of brake dust on the surface.

### DETAILED DESCRIPTION OF THE EMBODIMENTS

As will be described further hereinbelow, the present invention has unexpectedly and fortuitously provided a cleaning formulation which, after application to a surface (such as, for example, an automotive wheel surface) is adapted to substantially prevent build-up and/or adherence of brake dust on the surface.

A cleaning formulation according to an embodiment of the present invention includes a cleaning composition present in an amount sufficient to provide cleaning efficacy. The cleaning formulation further includes a brake dust barrier composition present in an amount sufficient to provide brake dust barrier efficacy. Without being bound to any theory, it is believed that the barrier composition, after application to a surface, is adapted to substantially prevent at least one of build-up and adherence of brake dust on the surface.

It is to be understood that the surface may be any surface which may come in contact with brake dust. In an embodiment, the surface is a wheel on a motor vehicle, such as for example, automobiles, SUVs, and/or other transportation vehicles.

Without being bound to any theory, it is believed that the brake dust barrier composition may be selected from any material which provides brake dust barrier efficacy as discussed herein. In an embodiment, the brake dust barrier composition includes, but is not limited to at least one of film forming compounds, fluorinated compounds, and mixtures thereof.

In an embodiment, the brake dust barrier composition is present in an amount ranging between about 0.1 wt. % and about 5 wt. % of the cleaning formulation. In an alternate embodiment, the brake dust barrier composition is present in an amount ranging between about 0.3 wt. % and about 3 wt. % of the cleaning formulation.

It is believed that the film forming compounds may be selected from any material which functions suitably in embodiments of the present invention. In an embodiment, the film forming compounds include, but are not limited to at least one of sulfonated styrene/maleic anhydride copolymers, sulfonated polystyrenes, linear silicone/ethylene oxide copolymers, modified polycarboxylate copolymers, acrylic polymers, silicone/acrylate copolymers, and mixtures thereof. Without being bound to any theory, it is believed that some film formers may work primarily by causing better/easier rinsing off of any brake dust which may accumulate on the surface.

A non-limitative example of a suitable acrylic polymer is commercially available under the tradename Alcoguard 2425 from Alco Chemical in Chattanooga, Tenn.

A non-limitative example of a suitable silicone/acrylate co-polymer is commercially available under the tradename FORMASIL 468 from Crompton Corporation in Middlebury, Conn.

In embodiments of the present invention, it may be desirable that the film forming compounds also exhibit some antistatic properties so as to aid in repelling from the surface at least some of the brake dust. Without being bound to any theory, it is believed that a brake dust barrier composition including a film forming compound exhibiting some antistatic properties may serve as at least a barrier to the adhesion of brake dust, if not as an actual repellent.

Non-limitative examples of film forming compounds which may also exhibit some antistatic properties include at least one of sulfonated styrene/maleic anhydride copolymers, sulfonated polystyrenes, linear silicone/ethylene oxide copolymers, and mixtures thereof.

A non-limitative example of a suitable linear silicone/ethylene oxide copolymer is commercially available under the tradename SILWET L-8600 from Crompton Corporation in Middlebury, Conn. SILWET L-8600 is a linear silicone/ethylene oxide copolymer that is —OH terminated (uncapped).

A series of some non-limitative examples of suitable film forming compounds which may exhibit some antistatic properties are commercially available under the tradename VERSA TL from Alco Chemical in Chattanooga, Tenn. The VERSA TL polymers are either sulfonated styrene/maleic anhydride copolymers or sulfonated polystyrenes. These polymers are film formers that can be cast from water. They also appear to exhibit some anti-static properties. Some non-limitative examples of suitable grades of VERSA TL include VERSA TL-4 (sulfonated styrene/maleic anhydride copolymer), VERSA TL-77 and VERSA TL-501 (sulfonated polystyrenes).

Both VERSA TL-4 and VERSA TL-77 appeared in screening tests to be efficacious by delaying the build-up of brake dust and allowing for easier hose-off once brake dust accumulation occurred.

It is to be understood that the fluorinated compounds may be any fluorinated compounds which function suitably in embodiments of the present invention. In an embodiment, the fluorinated compounds include at least one of fluorosurfactants and mixtures thereof. Non-limitative examples of fluorosurfactants are perfluorocarboxylic acid salts.

Some non-limitative examples of suitable fluorosurfactants are commercially available under the tradenames ZONYL FSO, ZONYL FSP, ZONYL FSA, and others, from E.I. duPont de Nemours and Company in Wilmington, Del.

The cleaning composition according to an embodiment of the present invention includes water and, optionally, at least one anionic surfactant present in an amount sufficient to aid in emulsifying soils. It is to be understood that any suitable water may be used, including but not limited to distilled water, de-ionized water, softened water, tap water, and mixtures thereof. In an embodiment, softened water is used. In an embodiment, the water is present in an amount ranging between about 50 wt. % and about 99 wt. % of the cleaning formulation. In an alternate embodiment, the water is present in an amount ranging between about 80 wt. % and about 95 wt. % of the cleaning formulation. It is to be understood that an embodiment of the cleaning formulation of the present invention may be made as a concentrated formulation (to which water would be added by the consumer before use).

It is to be understood that any suitable anionic surfactant may be used. In an embodiment, the anionic surfactant is at least one of lauryl sulfates, alkyl sulfates, fatty acids, linear alkyl benzene sulfonates, alkyl diphenyloxide sulfonates, sulfosuccinates, phosphate esters, sulfated ethoxylates, and mixtures thereof. In a further embodiment, the anionic surfactant is at least one of sodium lauryl sulfate, sodium alkyl sulfate, and mixtures thereof. In an embodiment, the anionic surfactant is present in an amount ranging between about 0 wt. % and about 10 wt. % of the cleaning formulation. In an alternate embodiment, the anionic surfactant is present in an amount ranging between about 1 wt. % and about 6 wt. % of the cleaning formulation.

A non-limitative example of a suitable sodium alkyl sulfate is commercially available under the tradename WITCOLATE WAC LA from Akzo Nobel Industrial Specialties, Inc. in Chicago, Ill.

In an embodiment of the present invention, the cleaning composition may further optionally include at least one dispersant present in an amount sufficient to aid in rinsing of soils. In an embodiment, the dispersant may be present in an amount ranging between about 0 wt. % and about 5 wt. % of the cleaning formulation. In an alternate embodiment, the dispersant may be present in an amount ranging between about 0.5 wt. % and about 2 wt. % of the cleaning formulation. It is to be understood that any suitable dispersant may be used. In an embodiment, the dispersant may be, but is not limited to modified polycarboxylate copolymers.

In a further embodiment of the present invention, the dispersant may optionally also exhibit film-forming characteristics and/or corrosion inhibition properties.

A non-limitative example of a suitable dispersant which also appears to exhibit film-forming characteristics and/or corrosion inhibition properties is a polycarboxylate copolymer commercially available under the tradename ALCOSPERSE 747 from Alco Chemical in Chattanooga, Tenn.

The cleaning composition according to an embodiment of the present invention may further optionally include a chelating agent present in an amount sufficient to aid in control of water hardness ions. In an embodiment, the chelating agent may be present in an amount ranging between about 0 wt. % and about 5 wt. % of the cleaning formulation. In an alternate embodiment, the chelating agent may be present in an amount ranging between about 0.1 wt. % and about 2 wt. % of the cleaning formulation. It is to be understood that any suitable chelating agent may be used. In a non-limitative embodiment, the chelating agent is tetrasodium ethylenediaminetetraacetate (EDTA). In a further embodiment, the chelating agent chosen may optionally also exhibit hard water germicidal efficacy.

A non-limitative example of a suitable chelating agent is commercially available under the tradename VERSENE100XL from Dow Chemical Company in Midland, Mich.

In an embodiment of the cleaning composition of the present invention, at least one nonionic surfactant may optionally be present in an amount sufficient to aid in removing oily soils. In an embodiment, the nonionic surfactant may be present in an amount ranging between about 0 wt. % and about 5 wt. % of the cleaning formulation. In an alternate embodiment, the nonionic surfactant may be present in an amount ranging between about 0.01 wt. % and about 1 wt. % of the cleaning formulation. It is to be understood that any suitable nonionic surfactant may be used. In a non-limitative embodiment, the nonionic surfactants include, but are not limited to ethoxylated alcohol nonionic surfactants, alkyl phenol ethoxylates; glycol esters; alkyl polyglycosides; and mixtures thereof.

A non-limitative example of an ethoxylated alcohol nonionic surfactant is commercially available under the tradename TOMADOL 25-7 from Tomah Reserve, Inc. in Reserve, La.

The cleaning composition according to an embodiment of the present invention may further optionally include a buffering agent present in an amount sufficient to render the formulation basic. In an embodiment, the buffering agent may be present in an amount ranging between about 0 wt. % and about 2 wt. % of the cleaning formulation. In an alternate embodiment, the buffering agent may be present in an amount ranging between about 0.1 wt. % and about 1 wt. % of the cleaning formulation. It is to be understood that any suitable buffering agent may be used. In a non-limitative embodiment, the buffering agent is sodium carbonate. It is to be understood that the pH of the formulation may be any suitable pH (although some desirable characteristics may be achieved in certain instances with a basic formulation, it is to be understood that the formulation may also be acidic or neutral if desired and/or necessitated by a particular end use). In an embodiment, the pH of the formulation is between about 8 and about 12. In a further embodiment, the pH of the formulation is about 10.

In a further embodiment of the cleaning composition of the present invention, a preservative is optionally included. In an embodiment, the preservative may be present in an amount ranging between about 0 wt. % and about 1 wt. % of the cleaning formulation. In an alternate embodiment, the preservative may be present in an amount ranging between about 0.01 wt. % and about 0.2 wt. % of the cleaning formulation. It is to be understood that any suitable preservative may be used. In a non-limitative embodiment, the preservative is a biocide. A non-limitative example of a biocide is commercially available under the tradename SURCIDE P from Surety Laboratories, Inc. in Piscataway, N.J.

In an embodiment of the cleaning formulation of the present invention, the cleaning composition includes water; sodium lauryl sulfate present in an amount sufficient to aid in emulsifying soils; a modified polycarboxylate copolymer present in an amount sufficient to aid in rinsing of soils; tetrasodium ethylenediaminetetraacetate (EDTA) present in an amount sufficient to aid in control of water hardness ions; an ethoxylated alcohol nonionic surfactant present in an amount sufficient to aid in removing oily soils; and a buffering agent present in an amount sufficient to render the formulation basic. A brake dust barrier composition formed from a sulfonated styrene/maleic anhydride copolymer is present in an amount sufficient to provide brake dust barrier efficacy.

To further illustrate the present invention, the following examples are given. It is to be understood that these examples are provided for illustrative purposes and are not to be construed as limiting the scope of the present invention.

### EXAMPLE 1

A cleaning formulation according to an embodiment of the present invention was prepared by admixing the following components in listed weight percentages.

| Ingredients | Weight % |
|---|---|
| Softened Water | 90.65 |
| Sodium Carbonate | 0.20 |
| Witcolate WAC LA | 5.00 |
| Versa TL 4 | 2.00 |
| Alcosperse 747 | 1.00 |
| Versene 100 XL | 1.00 |
| Tomadol 25-7 | 0.10 |
| Surcide P | 0.05 |

### EXAMPLE 2

The cleaning formulation of Example 1 was tested in the following manner. The front wheels were cleaned of cars identified as generally rapid brake dust generators. One wheel was cleaned with a control wheel cleaner that contained no brake dust barrier composition. The test wheel was cleaned with the cleaning formulation of Example 1. The control and test wheels were randomized between vehicles to attempt to prevent possible bias. Vehicles were driven for one week. The test wheels were compared visually by raters to the control wheels to identify whether the brake dust barrier composition included in the formulation of Example 1 was efficacious. These comparisons were done both before and after a water spray was applied.

Since wheels were rated against a control, paired t-tests were conducted on these data, where the null hypothesis was “the test wheel and the control wheel are the same.” For the data collected before the water rinse, the results of this analysis are shown immediately below.

Difference Before Rinse (all)
(with Ho and 95% t-confidence interval for the mean)

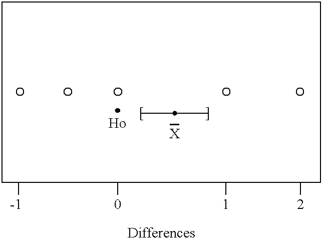

This analysis shows that the null hypothesis is false, and the data do show a difference (Reference−Cleaned Surface=Difference) to be positive, suggesting the cleaned/treated surface remained cleaner. This suggests that the formulation of Example 1 provided some protection against brake dust accumulation.

The same approach was used to analyze the data collected after the water rinse to assess whether wheel cleaning is made easier by using the formulation of Example 1. For the data collected after the water rinse, the results of this analysis are shown immediately below.

Differences After Water Rinse (all)
(with Ho and 95% t-confidence interval for the mean)

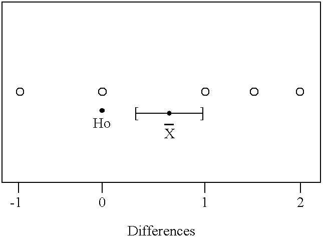

The results show the null hypothesis is false, and that there is a difference between the reference surface and the treated clean surface after the water rinse. These data therefore indicate that the treated wheels are easier to clean than the control wheels.

It was concluded from this testing that the cleaning formulation of Example 1 appears to aid in preventing the accumulation of brake dust, and in addition, appears to render wheels with some brake dust accumulation easier to clean.

While several embodiments of the present invention have been described in detail, it will be apparent to those skilled in the art that the disclosed embodiments may be modified. Therefore, the foregoing description is to be considered exemplary rather than limiting, and the true scope of the invention is that defined in the following claims.

1. A cleaning formulation adapted to be applied to a surface, the cleaning formulation comprising:
a cleaning composition present in an amount sufficient to provide cleaning efficacy; and
a brake dust barrier composition present in an amount sufficient to provide brake dust barrier efficacy;
wherein the barrier composition after application to the surface is adapted to substantially prevent at least one of build-up and adherence of brake dust on the surface.

2. The cleaning formulation as defined in claim 1 wherein the brake dust barrier composition comprises at least one of film forming compounds, fluorinated compounds, and mixtures thereof.

3. The cleaning formulation as defined in claim 2 wherein the film forming compounds have antistatic properties.

4. The cleaning formulation as defined in claim 3 wherein the film forming compounds comprise at least one of sulfonated styrene/maleic anhydride copolymers, sulfonated polystyrenes, linear silicone/ethylene oxide copolymers, and mixtures thereof.

5. The cleaning formulation as defined in claim 2 wherein the film forming compounds comprise at least one of sulfonated styrene/maleic anhydride copolymers, sulfonated polystyrenes, linear silicone/ethylene oxide copolymers, modified polycarboxylate copolymers, acrylic polymers, silicone/acrylate copolymers, and mixtures thereof.

6. The cleaning formulation as defined in claim 2 wherein the fluorinated compounds comprise at least one of fluorosurfactants and mixtures thereof.

7. The cleaning formulation as defined in claim 6 wherein the fluorosurfactant comprises perfluorocarboxylic acid salts.

8. The cleaning formulation as defined in claim 1 wherein the cleaning composition comprises:
water; and
at least one anionic surfactant present in an amount sufficient to aid in emulsifying soils.

9. The cleaning formulation as defined in claim 8 wherein the at least one anionic surfactant comprises at least one of lauryl sulfates, alkyl sulfates, fatty acids, linear alkyl benzene sulfonates, alkyl diphenyloxide sulfonates, sulfosuccinates, phosphate esters, sulfated ethoxylates, and mixtures thereof.

10. The cleaning formulation as defined in claim 8 wherein the cleaning composition further comprises at least one dispersant present in an amount sufficient to aid in rinsing of soils.

11. The cleaning formulation as defined in claim 10 wherein the at least one dispersant comprises modified polycarboxylate copolymers.

12. The cleaning formulation as defined in claim 10 wherein the at least one dispersant further exhibits at least one of film-forming characteristics and corrosion inhibition properties.

13. The cleaning formulation as defined in claim 8 wherein the cleaning composition further comprises a chelating agent present in an amount sufficient to aid in control of water hardness ions.

14. The cleaning formulation as defined in claim 13 wherein the chelating agent comprises tetrasodium ethylenediaminetetraacetate (EDTA).

15. The cleaning formulation as defined in claim 14 wherein the chelating agent further exhibits hard water germicidal efficacy.

16. The cleaning formulation as defined in claim 8 wherein the cleaning composition further comprises at least one nonionic surfactant present in an amount sufficient to aid in removing oily soils.

17. The cleaning formulation as defined in claim 16 wherein the at least one nonionic surfactant comprises at least one of ethoxylated alcohol nonionic surfactants, alkyl phenol ethoxylates, glycol esters, alkyl polyglycosides, and mixtures thereof.

18. The cleaning formulation as defined in claim 8 wherein the cleaning composition further comprises a buffering agent present in an amount sufficient to render the formulation basic.

19. The cleaning formulation as defined in claim 18 wherein the buffering agent comprises sodium carbonate.

20. The cleaning formulation as defined in claim 18 wherein the pH of the formulation is between about 8 and about 12.

21. The cleaning formulation as defined in claim 8 wherein the cleaning composition further comprises a preservative.

22. The cleaning formulation as defined in claim 21 wherein the preservative is a biocide.

23. A cleaning formulation adapted to be applied to a surface, the cleaning formulation comprising:
a cleaning composition present in an amount sufficient to provide cleaning efficacy, wherein the cleaning composition comprises:
water; and
at least one anionic surfactant present in an amount sufficient to aid in emulsifying soils; and
a brake dust barrier composition present in an amount sufficient to provide brake dust barrier efficacy, wherein the brake dust barrier composition comprises at least one of film forming compounds, fluorinated compounds, and mixtures thereof;
wherein the barrier composition after application to the surface is adapted to substantially prevent at least one of build-up and adherence of brake dust on the surface.

24. The cleaning formulation as defined in claim 23 wherein the film forming compounds have antistatic properties.

25. The cleaning formulation as defined in claim 24 wherein the film forming compounds comprise at least one of sulfonated styrene/maleic anhydride copolymers, sulfonated polystyrenes, linear silicone/ethylene oxide copolymers, and mixtures thereof.

26. The cleaning formulation as defined in claim 23 wherein the film forming compounds comprise at least one of sulfonated styrene/maleic anhydride copolymers, sulfonated polystyrenes, linear silicone/ethylene oxide copolymers, modified polycarboxylate copolymers, acrylic polymers, silicone/acrylate copolymers, and mixtures thereof.

27. The cleaning formulation as defined in claim 23 wherein the fluorinated compounds comprise perfluorocarboxylic acid salts.

28. The cleaning formulation as defined in claim 23 wherein the at least one anionic surfactant comprises at least one of lauryl sulfates, alkyl sulfates, fatty acids, linear alkyl benzene sulfonates, alkyl diphenyloxide sulfonates, sulfosuccinates, phosphate esters, sulfated ethoxylates, and mixtures thereof.

29. The cleaning formulation as defined in claim 26 wherein the cleaning composition further comprises:
at least one dispersant present in an amount sufficient to aid in rinsing of soils;
a chelating agent present in an amount sufficient to aid in control of water hardness ions;
at least one nonionic surfactant present in an amount sufficient to aid in removing oily soils; and
a buffering agent present in an amount sufficient to render the formulation basic.

30. The cleaning formulation as defined in claim 29 wherein the at least one dispersant comprises modified polycarboxylate copolymers and further exhibits at least one of film-forming characteristics and corrosion inhibition properties.

31. The cleaning formulation as defined in claim 29 wherein the chelating agent comprises tetrasodium ethylenediaminetetraacetate (EDTA) and further exhibits hard water germicidal efficacy.

32. The cleaning formulation as defined in claim 29 wherein the at least one nonionic surfactant comprises at least one of ethoxylated alcohol nonionic surfactants, alkyl phenol ethoxylates, glycol esters, alkyl polyglycosides, and mixtures thereof.

33. The cleaning formulation as defined in claim 29 wherein the buffering agent comprises sodium carbonate, and wherein the pH of the formulation ranges between about 10 and about 11.

34. The cleaning formulation as defined in claim 29 wherein the cleaning composition further comprises a biocidal preservative.

35. The cleaning formulation as defined in claim 29 wherein the water is softened.

36. An automotive cleaning formulation adapted to be applied to a wheel surface, comprising:
a cleaning composition present in an amount sufficient to provide cleaning efficacy, wherein the cleaning composition comprises:
water;
sodium lauryl sulfate present in an amount sufficient to aid in emulsifying soils;
a modified polycarboxylate copolymer present in an amount sufficient to aid in rinsing of soils;
tetrasodium ethylenediaminetetraacetate (EDTA) present in an amount sufficient to aid in control of water hardness ions;
an ethoxylated alcohol nonionic surfactant present in an amount sufficient to aid in removing oily soils; and
a buffering agent present in an amount sufficient to render the formulation basic; and
a brake dust barrier composition present in an amount sufficient to provide brake dust barrier efficacy, wherein the brake dust barrier composition comprises a sulfonated styrene/maleic anhydride copolymer;
wherein the barrier composition after application to the wheel surface is adapted to substantially prevent at least one of build-up and adherence of brake dust on the wheel surface.

37. The automotive cleaning formulation as defined in claim 36 wherein the modified polycarboxylate copolymer further exhibits at least one of film-forming characteristics and corrosion inhibition properties.

38. The automotive cleaning formulation as defined in claim 36 wherein the tetrasodium ethylenediaminetetraacetate (EDTA) further exhibits hard water germicidal efficacy.

39. The automotive cleaning formulation as defined in claim 36 wherein the buffering agent comprises sodium carbonate, and wherein the pH of the formulation is between about 9 and about 11.

40. The automotive cleaning formulation as defined in claim 36 wherein the cleaning composition further comprises a biocidal preservative.

41. The automotive cleaning formulation as defined in claim 36 wherein the water is softened.

42. The automotive cleaning formulation as defined in claim 36 wherein the water is present in an amount ranging between about 50 wt. % and about 99 wt. %; the amount of sodium lauryl sulfate ranges between about 0 wt. % and about 10 wt. %; the amount of modified polycarboxylate copolymer ranges between about 0 wt. % and about 5 wt. %; the amount of tetrasodium ethylenediaminetetraacetate (EDTA) ranges between about 0 wt. % and about 5 wt. %; the amount of ethoxylated alcohol nonionic surfactant ranges between about 0 wt. % and about 5 wt. %; the amount of buffering agent ranges between about 0 wt. % and about 2 wt. %; and the amount of brake dust barrier composition ranges between about 0.1 wt. % and about 5 wt. %.

43. The automotive cleaning formulation as defined in claim 42 wherein the amount of water is about 90 wt. %; the amount of sodium lauryl sulfate is about 5 wt. %; the amount of modified polycarboxylate copolymer is about 1 wt. %; the amount of tetrasodium ethylenediaminetetraacetate (EDTA) is about 1 wt. %; the amount of ethoxylated alcohol nonionic surfactant is about 0.1 wt. %; the amount of buffering agent is about 0.2 wt. %; and the amount of brake dust barrier composition is about 2 wt. %.

44. The automotive cleaning formulation as defined in claim 43 wherein the cleaning composition further comprises about 0.05 wt. % of a biocidal preservative.
